(19) United States
(12) Patent Application Publication
(10) Pub. No.: US 2008/0295106 A1
(43) Pub. Date: Nov. 27, 2008

(54) METHOD AND SYSTEM FOR IMPROVING THE AVAILABILITY OF A CONSTANT THROUGHPUT SYSTEM DURING A FULL STACK UPDATE

(76) Inventors: THOMAS R. GISSEL, Apex, NC (US); Marc Edward Haberkorn, Raleigh, NC (US); Viswanath Srikanth, Chapel Hill, NC (US)

Correspondence Address: DILLON & YUDELL LLP, 8911 N. CAPITAL OF TEXAS HWY., SUITE 2110, AUSTIN, TX, 78759, US

(21) Appl. No.: 11/752,019

(22) Filed: May 22, 2007

(51) Int. Cl. G06F 9/50

(52) U.S. Cl. 718/104

(57) ABSTRACT

A method for improving the availability characteristics of a constant throughput system that generates scores for multiple resources within multiple nodes in a software stack during a full stack update is disclosed. Each score includes at least a first weighted portion corresponding to a cost of bringing a resource offline, and a second weighted portion corresponding to a cost of re-routing service requests around the resource. An operating system (OS) selects a first node that has a lowest total score, re-routes service requests away from the resources of the first node, and brings the first node offline. The OS updates software of the resources in the first node with minimal disruption and brings the first node back online. The OS re-calculates the scores for the resources, and the OS selects a second node that has a new lowest total score. The OS repeats the process until all nodes are updated.

### BACKGROUND OF THE INVENTION

1. Technical Field

The present invention relates in general to data processing systems and in particular to constant throughput systems. Still more particularly, the present invention relates to an improved method and system for improving the availability characteristics of constant throughput systems during software updates.

2. Description of the Related Art

Computer system resources may fail and/or become outdated due to the development of new technology, thereby making a system update necessary. System updates include application level updates (i.e., high level updates that do not impair system availability), and full stack updates, which include more extensive software updates to the data store and middleware, and application programs. During an update, one or more computer system resources must be temporarily taken off line and subsequently modified or replaced before being brought back on line. The coordination and timing of computer system updates thus impacts the overall performance of any applications that require access to the computer system.

Computer applications often require constant access to computer system resources, such as data storage and processors. Although application level updates are minimally disruptive, full-stack software updates require that the data store, middleware, and one or more applications all be temporarily taken off line to be updated. Full-stack updates thus have the potential to be very disruptive to computer applications and/or users that require constant access (via the middleware) to one or more resources of a constant throughput computer system.

Conventional systems typically resolve this issue by utilizing multiple interconnected (i.e., redundant) computer systems, thereby enabling one system to carry the processing load while another system is temporarily brought offline for updates. Once updates are completed on one system, the processing load is subsequently shifted to the updated system while the un-updated system is temporarily brought offline and updated. Other constant throughput systems enable users to perform only application level software updates if a system is online, and do not permit full stack updates unless the system is offline.

Conventional constant throughput computer systems typically include multiple nodes, each of which in turn includes multiple resources. Furthermore, the processing load of the system during normal operations may be distributed among the various resources across multiple nodes. Thus, even when all of the resources are running on all of the nodes, only some of the resources are actively participating in the servicing of incoming requests. Consequently, the overall performance impact of performing an update on any given node (i.e., temporarily shifting processes to the resources of a redundant node, performing an update, and then having the node rejoin) may vary according to the number of active resources on the node and/or the current configuration of the computer system. As the complexity of constant throughput computer systems increases, this variability in impact of taking one or more particular nodes offline during a full stack update also increases.

### SUMMARY OF AN EMBODIMENT

Disclosed are a method, system, and computer program product for improving the availability characteristics of constant throughput systems during full stack software updates. An operating system (OS) generates scores for multiple resources within multiple nodes in a software stack during a full stack update. Each score includes at least a first weighted portion corresponding to a cost of bringing a resource offline, and a second weighted portion corresponding to a cost of re-routing service requests (i.e., active processes) around the resource. The OS dynamically selects a first node from among the multiple nodes that has a lowest total score, re-routes service requests away from the resources of the first node, and brings the first node temporarily offline. The OS updates software of the resources included in the first node with minimal disruption of system operation, and the OS brings the first node back online. The OS re-calculates the scores for the multiple resources, and the OS dynamically selects a second node that has a new lowest total score. The OS repeats the process until all nodes in the software stack are updated.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2 illustrates a block diagram of a middleware stack, according to an embodiment of the present invention;

FIG. 3 illustrates an exemplary resource scoring table, according to an embodiment of the present invention; and

FIG. 4 is a high level logical flowchart of an exemplary method of dynamically selecting nodes to minimize disruption during a full stack update, according to an embodiment of the invention.

### DETAILED DESCRIPTION OF AN ILLUSTRATIVE EMBODIMENT

The present invention provides a method, system, and computer program product for improving the availability characteristics of constant throughput systems during full stack software updates. As utilized herein, a full stack update refers to a software update that includes the middleware of a computer system.

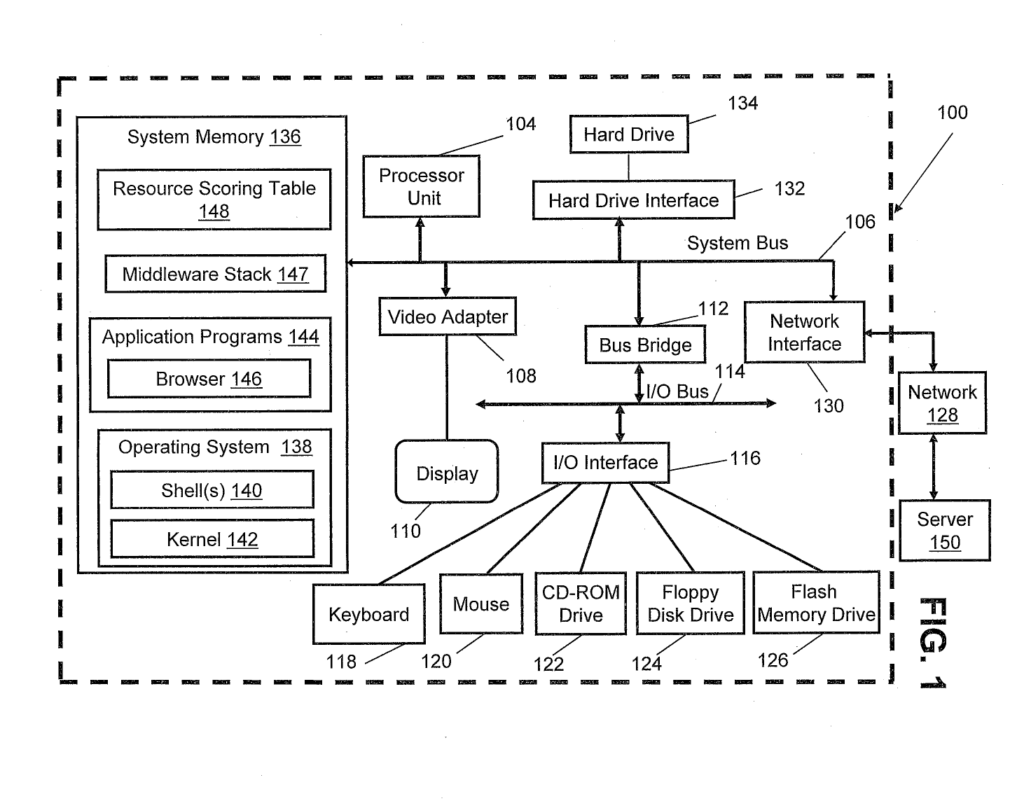

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, floppy disk drive 124, and flash memory drive 126. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as an Ethernet, a local area network (LAN), a wide area network (WAN), or a Virtual Private Network (VPN).

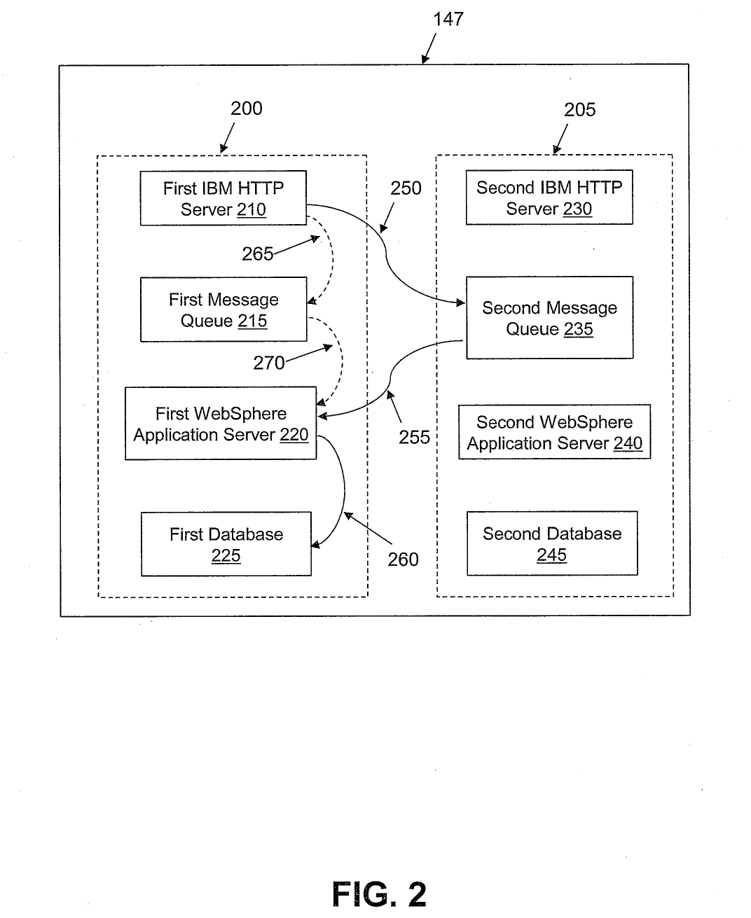

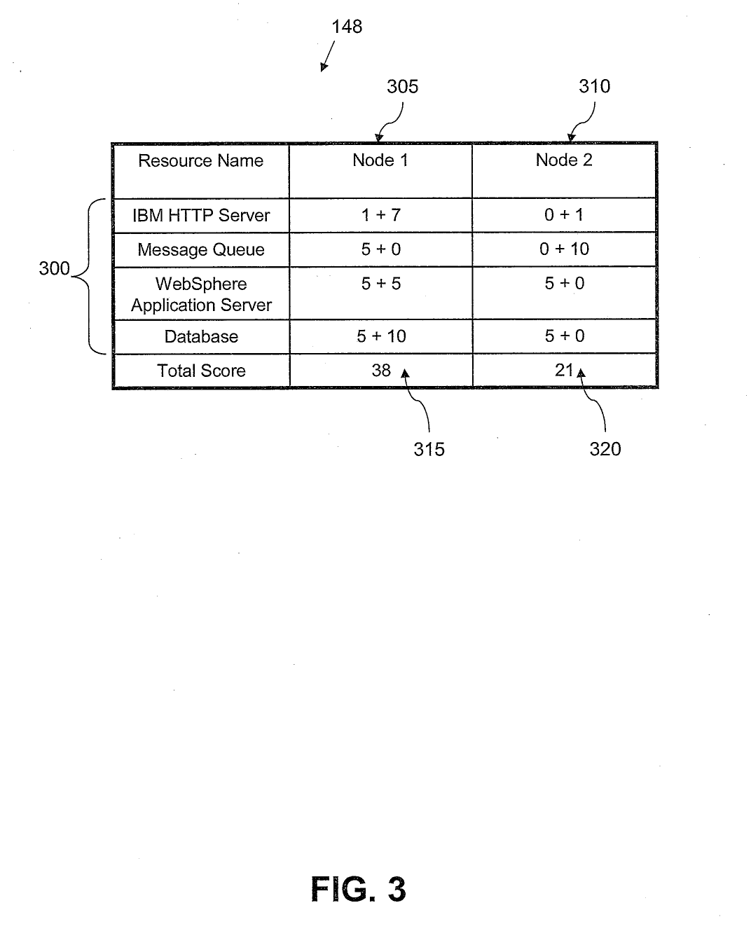

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes operating system (OS) 138 and application programs 144. System memory 136 also includes middleware stack 147 and resource scoring table 148 that are illustrated in FIGS. 2 and 3, respectively, which are discussed below. Although FIG. 1 depicts a middleware stack, the method illustrated in FIG. 3 may be applied to any type of software stack.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

Application programs 144 include browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

With reference now to FIG. 2, there is depicted a block diagram of middleware stack 147, according to an embodiment of the present invention. As shown, middleware stack 147 includes first node 200 and second node 205. In one embodiment, middleware stack 147 may include more than two nodes. First node 200 includes multiple resources, including, but not limited to, first IBM HTTP Server (IHS) 210, first message queue (MQ) 215, first WebSphere Application Server (WAS) 220, and first database (DB) 225. Similarly, second node 205 also includes multiple resources, including, but not limited to, second IHS 230, second MQ 235, second WAS 240, and second DB 245.

According to the illustrative embodiment, a client (e.g., server 150) issues a service request corresponding to an active process that utilizes multiple resources in first node 200 and/or second node 205. A service request typically flows in from the client and is directed by OS 138 to the resources that are deemed active at the time the service request is received. Consequently, service requests may utilize resources on one or more nodes. For example, a service request may initially utilize first IHS 200. OS 138 may subsequently direct the service request along path 250, such that the service request utilizes second MQ 235. OS 138 may subsequently direct the service request along path 255, thereby enabling the service request to utilize first WAS 220. The service request may follow path 260 and utilize first DB 225. The service request described above thus utilizes both first node 200 and second node 205.

During a full stack update, all nodes within middleware stack 147 are updated. However, a particular node can not be safely upgraded until all service requests that are utilizing the resources of the node are redirected to alternate resources in one or more other nodes. If OS 138 needs to perform a full stack update while maintaining the availability of multiple resources to service requests, OS 138 dynamically redirects service requests to one or more other nodes, as illustrated in FIG. 3, which is discussed below. After redirecting service requests from a node, OS 138 takes the node offline and performs updates on the node before bringing the node back online (i.e., enabling the node to re join the cluster of nodes). OS 138 thus re-routes service requests and takes each node within middleware stack 147 offline individually during updates.

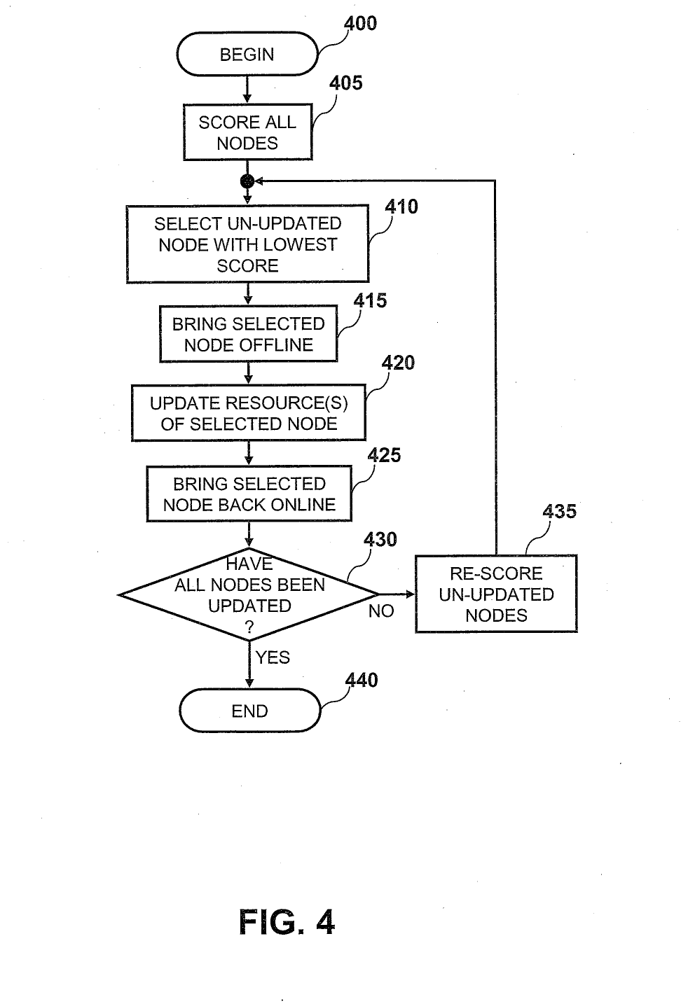

For example, if OS 138 determines that second node 205 should be updated first, OS 138 redirects incoming service requests along paths 265 and 270 instead of paths 250 and 255, thereby bypassing second node 205 and enabling second node 205 to be temporarily taken offline. OS 138 utilizes resource scoring table 148 to dynamically determine the order in which nodes are taken offline during updates, as illustrated in FIGS. 3 and 4, which are discussed below.

With reference now to FIG. 3, there is depicted an exemplary resource scoring table, according to an embodiment of the present invention. As shown, resource scoring table 148 includes multiple resource fields 300 and multiple node fields, such as first node field 305 and second node field 310, that correspond to each node within middleware stack 147. First node field 305 and second node field 310 each include scores for resource fields 300 that OS 138 combines to generate first node total score 315 and second node total score 320, respectively. The scores for each individual resource include a first weighted portion based on the cost of bringing the resource offline or online and a second weighted portion based on the cost of taking the resource out of service by re-routing service requests away from the resource when the resource is deemed “active” (i.e., currently utilized by a service request). OS 138 combines the first weighted portion and the second weighted portion to calculate the scores for each resource according to the method illustrated in FIG. 4, which is discussed below.

Turning now to FIG. 4, there is illustrated a high level logical flowchart of an exemplary method of dynamically selecting nodes to minimize disruption during a full stack update, according to an embodiment of the invention. The process begins at block 400 in response to OS 138 initiating a full stack update. OS 138 calculates a total score for each node within middleware stack 147, as depicted in block 205.

The total score for a node is the sum of the scores corresponding to each resource included in the node. The score for a resource includes two weighted portions, which when added together generate the score for the resource. According to the illustrative embodiment, the first weighted portion of a resource score is a number (e.g., an integer on a scale of 0 to 5, with 0 being low and 5 being high) corresponding to the time cost associated with bringing the resource offline or online. For example, if bringing first MQ 215 offline would cause a large disruption (i.e., heavily impair the availability of computer 100), OS 138 would set the first weighted portion of the resource score for first MQ 215 equal to 5. Similarly, if bringing second IHS 230 offline would cause a minimal disruption, OS 138 would set the first weighted portion of the resource score for second IHS 230 equal to a 0.

According to the illustrative embodiment, the second weighted portion of a resource score is a number (e.g., an integer on a scale of 0 to 10, with 0 being low and 10 being high) corresponding to the time cost associated with moving the resource from an active to an inactive state (i.e., re-routing service requests around the resource). For example, if moving second MQ 235 from an active state to an inactive state, as illustrated in FIG. 2, would cause a large disruption, OS 138 would set the second weighted portion of the resource score for second MQ 235 equal to a 10.

Returning now to FIG. 4, OS 138 selects an un-updated node that has the lowest total score in resource scoring table 148 (e.g., second node total score 320 in FIG. 3), as shown in block 410. OS 138 brings the selected node offline by temporarily re-routing incoming service requests from the resources of the selected node to alternate resources in one or more different nodes, as depicted in block 415. OS 138 updates the resources within the selected node, as shown in block 420. OS 138 subsequently brings the updated node back online (i.e., makes the resources of the updated node available to incoming service requests), as depicted in block 425.

At block 430, OS 138 determines whether all nodes within middleware stack 147 have been updated. If all nodes within middleware stack 147 have not been updated, OS 138 re-calculates the total scores for each of the un-updated nodes, as shown in block 435, and the process returns to block 410. In another embodiment, OS 138 re-calculates the scores for all of the nodes within middleware stack 147 and assigns a default value (e.g., a very high score) to critical resources and/or updated nodes, thereby preventing the critical resources and/or updated nodes from being selected for an update at block 410. If all nodes within middleware stack 147 have been updated, the process terminates at block 440. In yet another embodiment, OS 138 may utilize a scoring mechanism based on the needs of a particular constant throughput system and/or may involve additional variables in the calculation of each resource score, including, but not limited to, resource size, update size, and processor speed.

The present invention thus improves the availability characteristics of constant throughput systems during full stack updates. OS 138 generates scores for multiple resources within multiple nodes in a software stack during a full stack update. Each score includes at least a first weighted portion corresponding to a cost of bringing a resource offline, and a second weighted portion corresponding to a cost of re-routing a service request around the resource. OS 138 dynamically selects a node from among the multiple nodes that has a lowest total score (e.g., node 2 in FIG. 3), re-routes service requests away from the resources of the first node, and brings the selected node temporarily offline. OS 138 updates software of the resources included in the selected node with minimal disruption, and OS 138 brings the selected node back online. OS 138 re-calculates the scores for the multiple resources, and OS 138 dynamically selects another node that has a new lowest total score (e.g., node 1 in FIG. 3). OS 138 repeats the process until all nodes in the software stack are updated.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 4) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
generating scores for a plurality of resources of a plurality of nodes in a software stack, wherein said scores include at least a first weighted portion and a second weighted portion;
selecting a first node that has a lowest total score from among said plurality of nodes;
bringing said first node temporarily offline;
updating software of at least one resource of said first node;
bringing said first node back online;
re-generating said scores for said plurality of resources;
selecting a second node that has a new lowest total score from among said plurality of nodes; and
continuing until all of said plurality of nodes have been updated.

2. The method of claim 1, wherein said first weighted portion further comprises a scaled number corresponding to a cost of bringing a resource offline and said second weighted portion further comprises a scaled number corresponding to a cost of re-routing a service request around said resource.

3. The method of claim 1, wherein bringing said first node temporarily offline further comprises re-routing services of said first node to one or more alternate nodes.

4. A computer system comprising:
a processor unit;
a memory coupled to said processor unit;
an operating system within said memory;
one or more application programs within said memory;
a middleware stack within said memory, wherein said middleware stack provides an interface between said application programs and an external client;
a resource scoring table within said memory;
means for generating scores for a plurality of resources of a plurality of nodes in said middleware stack, wherein said scores include at least a first weighted portion and a second weighted portion;
means for selecting a first node that has a lowest total score from among said plurality of nodes;
means for bringing said first node temporarily offline;
means for updating software of at least one resource of said first node;
means for bringing said first node back online;
means for re-generating said scores for said plurality of resources;
means for selecting a second node that has a new lowest total score from among said plurality of nodes; and
means for continuing until all of said plurality of nodes have been updated.

5. The computer system of claim 4, wherein said first weighted portion further comprises a scaled number corresponding to a cost of bringing a resource offline and said second weighted portion further comprises a scaled number corresponding to a cost of re-routing a service request around said resource.

6. The computer system of claim 4, wherein said means for bringing said first node temporarily offline further comprises means for re-routing services of said first node to one or more alternate nodes.

7. A computer program product comprising:
a computer storage medium; and
program code on said computer storage medium that that when executed provides the functions of:
generating scores for a plurality of resources of a plurality of nodes in a software stack, wherein said scores include at least a first weighted portion and a second weighted portion;
selecting a first node that has a lowest total score from among said plurality of nodes;
bringing said first node temporarily offline;
updating software of at least one resource of said first node;
bringing said first node back online;
re-generating said scores for said plurality of resources;
selecting a second node that has a new lowest total score from among said plurality of nodes; and
continuing until all of said plurality of nodes have been updated.

8. The computer program product of claim 7, wherein said code for said first weighted portion further comprises code for a scaled number corresponding to a cost of bringing a resource offline and said code for said second weighted portion further comprises code for a scaled number corresponding to a cost of re-routing a service request around said resource.

9. The computer program product of claim 7, wherein said code for bringing said first node temporarily offline further comprises code for re-routing services of said first node to one or more alternate nodes.
